(19) United States
(12) Patent Application Publication
(10) Pub. No.: US 2015/0230044 A1
(43) Pub. Date: Aug. 13, 2015

(54) UPDATING VEHICLE SOFTWARE USING A SMARTPHONE

(71) Applicant: Continental Automotive Systems, Inc., Auburn Hills, MI (US)

(72) Inventor: Stefan Paun, Park Ridge, IL (US)

(21) Appl. No.: 14/179,142

(22) Filed: Feb. 12, 2014

(51) Int. Cl. H04W 4/00; H04L 29/08; G06F 17/30; G06F 9/445

(52) U.S. Cl. CPC H04W 4/008; G06F 8/65; H04L 67/12; G06F 17/30091; H04W 4/14

(57) ABSTRACT

Software for embedded vehicle computers in a motor vehicle is updated using a smart phone having Bluetooth connectivity or USB connectivity. An application program or “app” running the phone queries a server via the Internet, for any available software updates for a vehicle. The vehicle is identified to the server by the app using the vehicle identification number (VIN). When an update for an embedded computer is available, the server transfers the update as one or more files, which are transmitted to the phone via a cell phone network and stored in the phone until the phone can be linked to the vehicle. After the phone and vehicle are linked the update is transferred to the vehicle, preferably using Bluetooth. Software on the vehicle copies the new software into an appropriate memory device via a bus running through-out the vehicle.

### BACKGROUND

Most vehicles being manufactured today have multiple computer-controlled systems, examples of which include the engine control unit or ECU, anti-lock brakes, air bags and an anti-theft system. The computers or processors that control such systems are referred to interchangeably as either embedded processors or embedded computers. They run software that is provided to the embedded processors when the vehicle is manufactured.

There may be several reasons why the software for an embedded computer might require a modification or improvement over the life of a vehicle. Regardless of the reason, updating the software for an embedded processor typically requires special equipment at an authorized service center or dealer or a complete replacement of an embedded processor and/or the memory devices storing the processor's software. Updating software on thousands of cars can also cost millions of dollars. An apparatus and method for updating the software used in a vehicle's embedded processor that does not require a trip to the dealership or an equipment replacement would be an improvement over the prior art.

### BRIEF DESCRIPTION OF THE FIGURES

FIG. 1 depicts a system for updating the software for a computer that is embedded in a motor vehicle using a smart phone;

FIG. 2A is a block diagram of an apparatus, located at a vehicle, which updates embedded processor software using a download obtained from a smart phone;

FIG. 2B is an alternate embodiment of the apparatus shown in FIG. 2A;

FIG. 3 is a block diagram of a smart phone, configured to provide software to an embedded vehicle computer via either a wireless or wired communication link between the smart phone and vehicle; and

FIG. 4 depicts steps of a method of updating software in an embedded computer using a smart phone.

### DETAILED DESCRIPTION

As used herein, the word, “software” refers to one or more executable computer program instructions that make computer hardware work. An executable computer program instruction is a statement in any form of programming language, including machine language, assembler and high-level languages, specifying one or more operations to be performed by a computer. An executable instruction can include addresses and/or values of operands associated with an instruction.

A “file” is considered to be a complete and usually named collection of information, such as collection of program instructions, a set of data used by a program or user-created documents. Files in a computer or memory device are made up of binary-valued numbers. When a file is created it is usually named. A file can be transmitted, received or stored by transmitting, receiving or storing binary-valued numbers comprising the file.

An “embedded computer” is considered to be a computer or computer system that is part of, and which is connected to a larger system. An embedded computer performs at least some of the operational requirements of the larger system. “Embedded computer” also refers to a computer or processor that is built in to, or which forms a part of a computer-controlled device, machine or circuit.

The microprocessors, microcontrollers and digital signal processors (DSPs) that control cellular telephones, televisions, microwave ovens, CAT scanners, navigation systems and robots are examples of embedded computers. Processors that control vehicle engines, transmissions, anti-lock brakes, air bags and infotainment systems are also embedded computers. Laptops, tablets and desktop personal computers, on the other hand are not embedded computers because they are not built into, nor do they control a specific device, machine or circuit.

As used herein, “bus” refers to a set of one or more electrical conductors in a computer system that forms a main transmission path. A bus is essentially a shared highway that connects different parts of a system together. Most busses consist of specialized groups of electrically-parallel conductors or lines that carry different types of information, examples of which are the address, data and control buses commonly found on microprocessors and microcontrollers. A bus can also consist of a single conductor or line that carries different types of information at different relative times. The Controller Area Network or “CAN” bus and the Flexray bus are well-known busses used in vehicles to connect devices to each other. Ethernet is another form of bus that can be used to connect devices together.

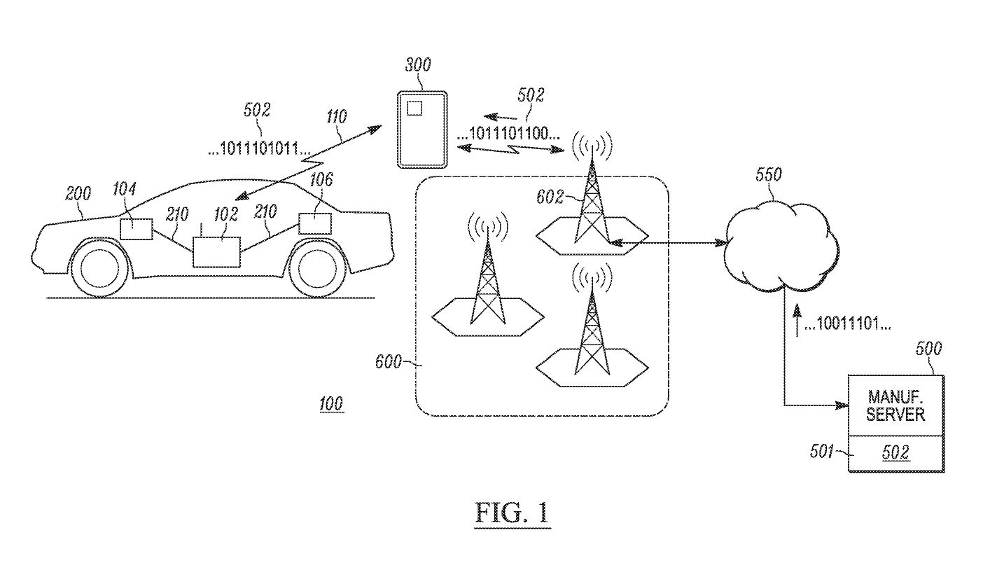

FIG. 1 depicts a system 100 for updating software for a computer, embedded in a motor vehicle 200, using a conventional, mobile cellular telephone 300 commonly known as a “smart phone,” but which is not part of the vehicle 200. Since the smart phone 300 is not part of the vehicle, it can be carried about and used away from the vehicle 200. In order to distinguish such a phone from embedded cell phones that are “embedded” in a vehicle and provide telematics functionality like OnStar, the mobile cellular telephone or smart phone 300 is referred to instead as an “extra-vehicle, mobile cellular communications device 300”, or simply “device 300.”

The wireless communications capabilities provided to cell phones generally as well as the device 300 shown in FIG. 1, are provided in large part by a cellular network 600. Those communication capabilities include the ability to access the Internet and web sites thereon using a smart phone browser or equivalent thereof, which is installed when the device 300 is manufactured or which is loaded into the device 300 as an application program or “app” by a user. In addition to a browser, smart phones and the device 300 are also able to store and run other apps. By virtue of such capabilities, the extra-vehicle, mobile cellular communications device 300 is able to request, receive, store and transmit files via the communications network provided by a cellular service provider. In addition to being able to send and receive files through a cellular network, however, smart phones are also able to couple or link to “Bluetooth” device.

In FIG. 1, the extra-vehicle, mobile cellular communications device 300 is shown accessing a web server 500 for the vehicle's manufacturer, not shown in the figure. The web server 500, which comprises a computer and non-transitory memory 501, is able to store and transmit one or more files 502, including files 502 that comprise software for a computer that is embedded in a vehicle. Since the server 500 is connected to the Internet 550, which is accessible to the device 300 through a cellular network 600, the server 500 is thereby able to transfer files 502 to and from the device 300 over a communications path, at least the last portion of which is wireless because it exists between the device 300 and a cell tower 602 of the cellular network 600. Files that the extra-vehicle, mobile cellular communications device 300 transmits or receives through any radio frequency transmission and/or reception are therefore considered herein to have been transmitted and/or received wirelessly.

The vehicle 200 shown in FIG. 1 comprises multiple embedded computers, three of which are shown, represented by rectangles identified by reference numerals 102, 104 and 106. The embedded computers are also referred to herein as embedded processors. Each embedded processor or computer 102, 104, 106 comprises a microprocessor, microcontroller or digital signal processor and an associated, non-transitory memory device, not shown in FIG. 1, which stores software for a processor coupled to the memory. As is well known, processors and associated memory devices are coupled to each other by a bus. In at least one embodiment, the embedded computers 102, 104 and 106 control one or more of the vehicle's engine, transmission, anti-lock brakes, air bags, a GPS navigation system and “infotainment” system.

The embedded computers 102, 104 and 106 depicted in FIG. 1, including the computer 206 for the communications device 202 are all coupled to at least one bus that runs through-out the vehicle 200 and is therefore referred to herein as a vehicle bus 210. Embedded computers coupled to the vehicle bus 210 are therefore able to communicate with each other, as well as any other device connected to the same vehicle bus 210, including devices the embedded computers control.

Still referring to FIG. 1, software and software updates for one or more of the embedded computers 102, 104, 106 embedded in the vehicle 200, are stored on the server 500 as one or more files 502. In a preferred embodiment, one or more such files 502 are transmitted by the server 500 to the extra-vehicle, mobile cellular communications device 300 responsive to a file download request sent to the server 500 by the device 300. In an alternate embodiment, however, the server 500 can affirmatively notify the device 300, by way of a text message sent to the device 300, stating therein that new or revised software is available for download. When a file has been received by the device 300, software that controls an embedded processor in the device 300 causes the device 300 to notify the user of the device 300 of the availability of a download, i.e., a file 502, for the vehicle 200. Such notification is preferably by way of an activated icon on a user interface for the device 300, a text message or an audible alarm.

In order to transfer software to the vehicle, files 502 kept at the server 500 are first transmitted to the device 300 through the Internet 550, being wirelessly between the cellular network 600 and the device 300. Files 502 received by the extra-vehicle, mobile cellular communications device 300 are stored within the device 300 in a non-transitory memory, until a later time when the files 502 can be downloaded to the vehicle 200 from the device 300, through either a separate wireless link 110 between the vehicle 200 and device 300 or through a wired connection, not shown.

A separate wireless link 110 between the device 300 and vehicle 200 is preferably provided by a short-range radio frequency protocol, which is preferably Bluetooth. The Bluetooth protocol is well known to those of ordinary skill in the art. Further discussion of the Bluetooth protocol is therefore omitted for brevity.

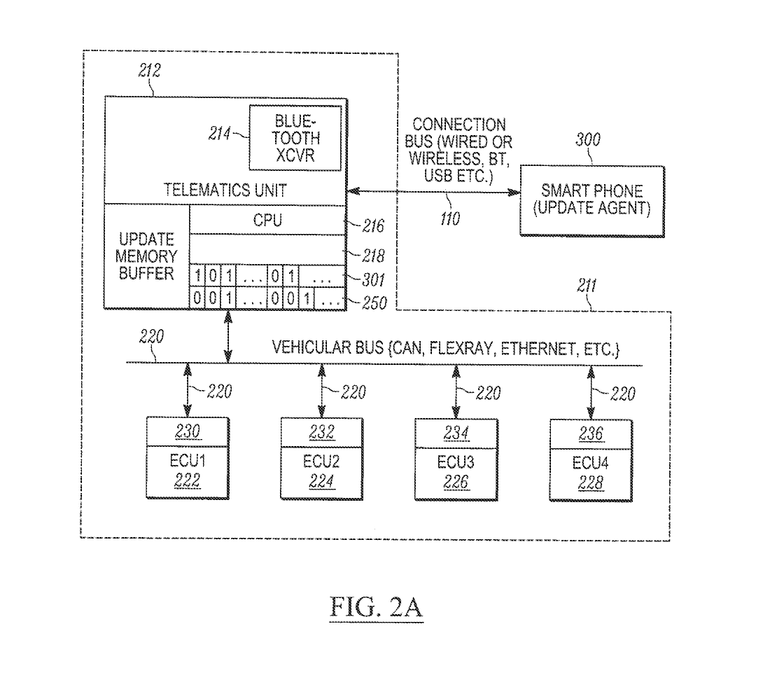

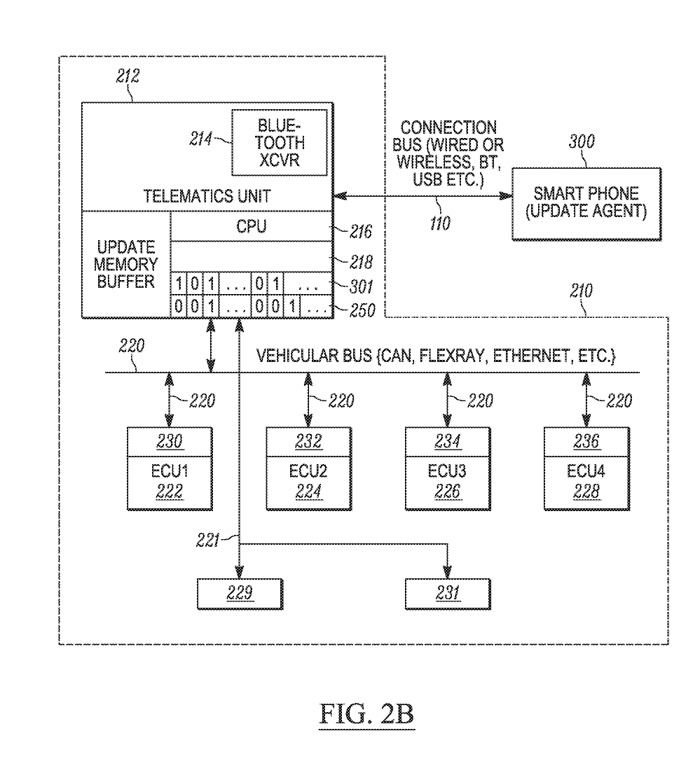

FIG. 2A is a block diagram of an apparatus 210 for a vehicle, not shown in FIG. 2A, which enables software for vehicle-embedded computers to be updated via a communication link 110 between an extra-vehicle, mobile cellular communications device 300, commonly known as a “smart phone” and an apparatus within the vehicle that is configured to receive file downloads from the device 300.

In a preferred embodiment, the apparatus 210 comprises a telematics unit 212, which is provided with a two-way communications device 214, preferably embodied as a short-range radio frequency receiver and transmitter, the combination of which is referred to hereinafter as a transceiver 214. In a preferred embodiment, the communications device 214 is a Bluetooth host. In an alternate embodiment, the communications device 214 is simply a universal serial bus (USB) interface, a USB connector and USB cable, which are well known to those of ordinary skill in the computer art and therefore omitted from FIG. 2A and FIG. 2B.

Bluetooth is a wireless communication protocol in the unlicensed industrial, scientific, medical (ISM) band at 2.4 GHz using a frequency-hopping transceiver. Originally developed by the Bluetooth Special Interest Group (SIG), it allows real-time voice and data communications between Bluetooth hosts. The Bluetooth link protocol is based on time slots. Bluetooth links between Bluetooth-capable devices are well known. Further description of them is therefore omitted for brevity.

The telematics unit 212 has its own embedded computer 216. The embedded computer 216 is coupled to the communications device 214 such that information-bearing binary-valued signals can be sent to and from the computer 216 through the communications device 214.

The embedded computer 216 is also connected to a non-transitory memory device 218 and a vehicle bus 220, so named because the vehicle bus 220 runs through-out the vehicle, connecting various embedded computers to each other and to peripheral devices controlled by one or more of the embedded computers. The embedded computer 216 is configured to send files embodied as binary-valued signals, to other embedded computers coupled to the vehicle bus 220. The computer 216 in the communications device 214 can therefore considered to be a “master” of the bus or bus master, at least while it is transmitting files over the vehicle bus 220 to another embedded computer that is also coupled to the same bus 220.

In a preferred embodiment, the embedded computer 216 effectuates file transfers by sending files to embedded, destination computers on the vehicle bus 220. A recipient embedded computer 222, 224, 226 or 228, stores files that it receives over the bus 220, into its own corresponding non-transitory memory device 230, 232, 234 and 236. In one alternate embodiment, which uses conventional address, data and control lines, well known to those of ordinary skill, the vehicle bus 220 is connected directly to non-transitory memory devices. The direct connection of address, data and control lines to memory devices enable the embedded computer 216 for the telematics unit 212 to write or transfer software and data directly into a non-transitory memory device, as well as read software and data from those non-transitory memory devices akin to direct memory access or DMA.

Those of ordinary skill in the art will recognize that the embedded computers 216, 222, 224, 226 and 228 shown in FIG. 2A are all coupled to the one, same vehicle 220. In an alternate embodiment shown in FIG. 2B, however, two different vehicle busses 220 and 221 are used to connect different embedded computers to each other. In such an embodiment, the multiple different busses can use the same or different protocols.

By way of example, in FIG. 2B, the four different and separate embedded computers 222, 224, 226, 228 shown in FIG. 2A are coupled to a first bus 220 using a first communications protocol. Two different and separate embedded computers 229 and 231 are coupled to a second vehicle bus 221. The second bus 221 can use the same or a different communications protocol as that used on the first bus 220. In such an embodiment, both busses 220, 221 are coupled to the same embedded computer 216 of course in order to enable file transfers from the one embedded computer 216 to all other embedded computers, albeit through different vehicle busses 220 and 221.

Referring again to FIG. 2A, the non-transitory memory device 218 in the communications device 214 stores software for the computer 216. The non-transitory memory 218, typically embodied as an electrically erasable programmable read only semi-conductor memory, is sized, however, to be able to store software for both the embedded computer 216 and software for one or more other embedded computers 222, 224, 226 and 228 coupled to the vehicle bus 220. The non-transitory memory device 208 thus provides a temporary storage media for update software received from an extra-vehicle cellular communications device 300.

Those of ordinary skill in the will recognize that transferring files over a bus typically requires the bus to be made unavailable for other purposes, at least while the file and its constituent data is actually being carried over the bus. If a vehicle bus 220 can't be used by embedded computers in a vehicle, the devices or systems controlled by embedded computers might not work. Large software updates are therefore preferably accomplished by sending updates in packets, which are segments or pieces of a file. Sending and receiving a file using packets is well known to those of ordinary skill in the art. A description of various types of packets and their transmission over a network is therefore omitted for brevity.

The embedded computers 212, 214, 216 and 218 are coupled to corresponding memory devices 230, 232, 234, 236 and the vehicle bus 220. Each embedded computer 222, 224, 226, 228 is able to receive and send files over the vehicle bus 220, including files that comprise replacement or updated software for the embedded computers as well as the embedded computer 216 for the telematics unit 212.

In one embodiment, the vehicle bus 220 is embodied as a controller area network or “CAN” bus, which is a bus protocol, well known to those of ordinary skill in the vehicle electronics art. The CAN bus protocols are incorporated by reference herein.

In another embodiment, the vehicle bus 220 is a FlexRay bus which is a communications protocol developed for in-vehicle network communications. It is now a set of ISO standards, well known to those of ordinary skill and incorporated herein by reference.

In yet another embodiment, the vehicle bus 220 is an Ethernet bus. Ethernet is also well known.

Software updates for the embedded computers 222, 224, 226 and 228, including the embedded computer 216 for the telematics unit 212, are received as one or more files downloaded to the communications device 214 and then to the telematics unit computer 216, from the aforementioned, extra-vehicle, mobile cellular communications device 300. On a CAN bus, all devices “listen” on the bus and respond only to messages that have an identification (ID) code that corresponds to or identifies an embedded computer. In another embodiment, When an ID for an embedded computer is received, a software update for the embedded computer can be transferred to the corresponding computer using conventional CAN bus file transfer techniques, well known to those of ordinary skill in the art.

Software for an embedded computer in a vehicle should be provided by, or obtained from an authorized entity, preferably the vehicle's manufacture. The ability of the communications device 300 to receive embedded computer software from the vehicle's manufacturer and its ability to transmit or forward such software is therefore controlled.

In a preferred embodiment, the extra-vehicle cellular communications device 300 is “registered” to the vehicle 200 by programming a unique identifier 301 for the extra-vehicle cellular communications device 300 into the non-transitory memory device 218 for the controller 216 in the telematics unit 212. The unique identifier 301 is preferably programmed into the memory 218 by a vehicle manufacturer-authorized dealer or manufacture-authorized service agent. Computer program instructions for the embedded computer 216 in the telematics unit 212 cause the computer 216 to thereafter search for the unique identifier 301 in files received by the telematics unit 202. If the unique identifier 301 is not received from the device 300, program instructions for the embedded computer 216 for the telematics unit 212 cause the computer 216 to consider received files as being unauthorized or as containing files that are not software for an embedded computer. The computer 216 will therefore not transfer a received file into any memory device for an embedded computer.

A unique identifier 301 for the extra-vehicle cellular communications device 300 is preferably embodied as a multi-digit number that unambiguously identifies the extra-vehicle cellular communications device 300 as one that is owned or controlled by the owner of the vehicle 200. Software received from the device 300 is thus considered authentic, i.e., obtained from a device 300 owned by the owner of vehicle 200. The identifier 301 is thus considered to be an authenticator for the extra-vehicle cellular communications device 300.

In one embodiment, the authenticator 301 is the electronic serial number or ESN for the extra-vehicle cellular communications device 300. The ESN of a cell phone is well known to those of ordinary skill in the art as a multi-digit number programmed into the device 300 by the manufacturer of the device 300 when the device 300 is manufactured.

Every motor vehicle is provided or assigned a vehicle identification number or VIN by its manufacturer. The VIN uniquely identifies a vehicle and at least some of the equipment it was manufactured with.

In a preferred embodiment, a VIN for the vehicle 200 is stored in the memory device 218 as a string of alpha-numeric values 250, from which the VIN can be provided to the extra-vehicle cellular communications device 300 and stored in a memory device 218 of the device 300 as a string of characters 250. Software in the device 300 provides the VIN to the manufacturer's web server 500 prior to, and as a pre-condition to obtaining software for the vehicle from the server 500. The VIN enables the server 500 to identify files 502 for the vehicle.

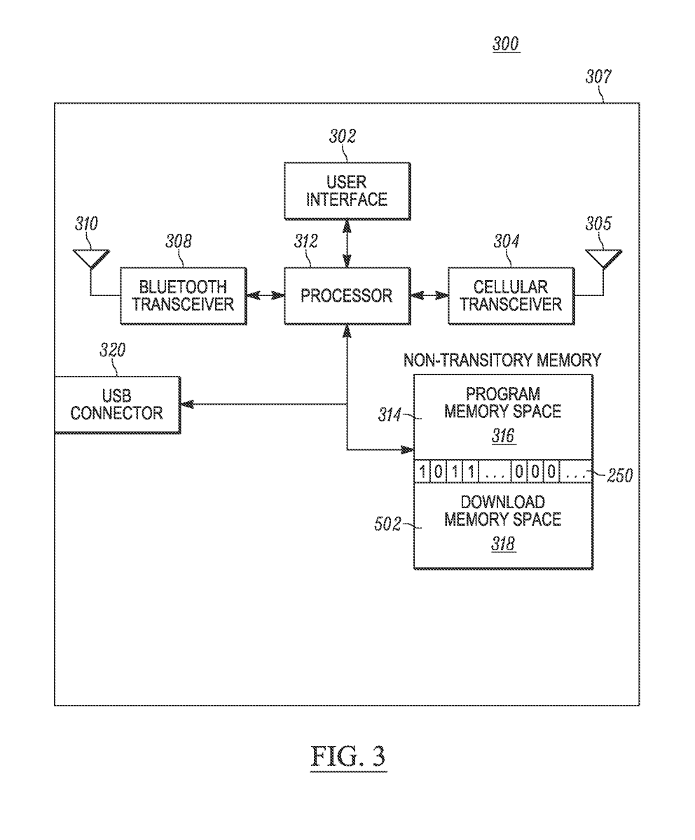

FIG. 3 is a block diagram of an extra-vehicle mobile cellular communications device 300, configured to provide software to an embedded vehicle computer. The device 300 comprises a user interface 302 preferably embodied as a capacitive-sensitive display screen, well known in the art. The device 300 also comprises a conventional cellular transmitter and receiver, referred to herein after as a cellular transceiver 304. Radio frequency signals are received by and transmitted from the cellular transceiver 304 through an antenna 305, commonly located within the housing 307 within which the devices shown in FIG. 3 are located.

A Bluetooth transceiver 308, also within the housing 307 and part of the device 300, sends and receives radio frequency signals through a corresponding Bluetooth antenna 310, also located with the housing 307.

The user interface 302, cellular transceiver 304 and Bluetooth transceiver 308 are coupled to an embedded processor 312 for the device 300. The embedded processor 312 executes program instructions stored in a non-transitory memory device 314. The non-transitory memory device 314 has at least a first memory space 316, which stores program instructions executed by the processor 308 and a second memory space 318 allocated to receive and store files and other information downloaded by the device 300 through the cellular transceiver 304 and which will be transmitted from the device 300 via the Bluetooth transceiver 308 or via a conventional USB connector/port 320, also coupled to the processor 312. Stated another way, information and files in the download memory space 318 can be received from the cellular transceiver 304 and transmitted through either the Bluetooth transceiver 308 or a USB port 320.

Program instructions in the program memory space 316 are selected and arranged such that when they are executed by the processor 312 they cause the processor 312 to control the cellular transceiver 304, the user interface 302, the Bluetooth transceiver 308 and the USB port 320. Those instructions effectively cause the processor 308 to receive a file received by the transceiver 304 from a wireless communications network, not shown in FIG. 3, but preferably a cellular network 600. Other instructions in the program memory space 316 cause the processor 308 to store received files in the download memory space 318. Other program instructions cause the processor 308 to retrieve a stored file or portions thereof, from the download memory space 314 and transmit those files or portions thereof from either the Bluetooth transceiver 308 or the USB port 320.

In a preferred embodiment, program instructions in the program memory space 316 cause the processor 308 to first monitor the user interface 302 for an input from a user of the device 300. Such an input is typically a user's tactile interaction with a touch sensitive display device. When a user input is received, the processor 312 directs the cellular transceiver 304 to begin a wireless communications session through a cellular network 600 by which the device 300 accesses a website 500 hosted by a vehicle manufacturer and request a download of software.

In order to receive software for a vehicle's embedded computers, the device 300 needs to identify the vehicle into which the software will be downloaded. In a preferred embodiment, program instructions in the program memory space 316 cause the processor 308 to effectuate the transmission of a vehicle identification number, stored in the program memory space 316 as a string of alpha-numeric characters 250. The server transmits software for a vehicle to the device 300 as a file 502, after the server receives at least the VIN.

After a file 502 is downloaded to the device 300, program instructions in the program memory space 312 cause the processor 300 to initiate a communications session with a vehicle communications device 212, preferably a Bluetooth transceiver 306 but optionally a USB interface. When a communications session is established, program instructions cause the processor 308 to retrieve a file 502 from the download memory space 318 and transmit the file 502 from either the Bluetooth transceiver 308 or a USB port 320. The file that was previously received via the cellular transceiver 304 and stored in the download memory space 318 is thereby provided to a vehicle 200 via a cell phone.

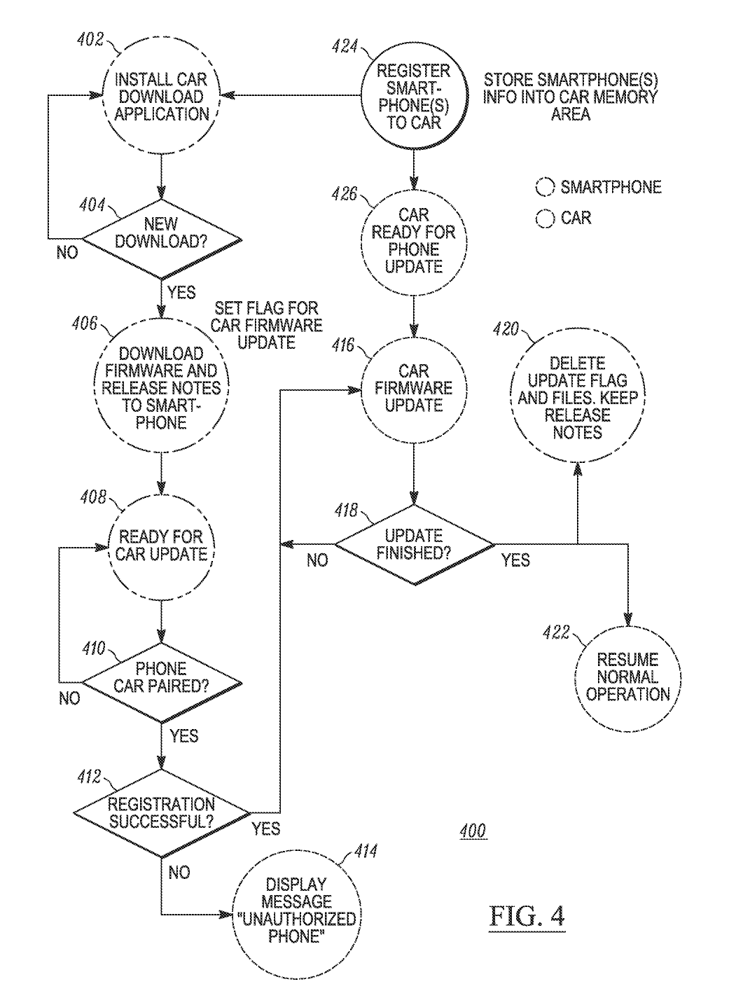

FIG. 4 depicts steps of a method of updating software in an embedded computer using a smart phone.

In a first step 402, a vehicle software update application or “app” is installed into a conventional smartphone after which, the device is able to function as an extra-vehicle, mobile cellular communications device 300.

After the “app” download is determined to have been completed at step 404, the device 300 is able to download software at step 406 including release notes and other information and store that downloaded information internally.

After a software download is completed, the device 300 initiates communications with a vehicle and at steps 408 and 410, responsive to a download command received by the device 300 through its user interface. A determination is then made at step 408 whether the car is ready for an update and whether Bluetooth hosts have been paired. If the registration of the two Bluetooth devices to each other is successful, as determined at step 410, at step 412 a decision is made whether to begin the download. If the Bluetooth registration was unsuccessful, an error message is provided to the device as shown at step 414. If the registration was successful, the software is downloaded to the vehicle at 416.

When an embedded computer software download is determined to have completed as shown at step 418, any updated software that was downloaded into the device 300 is deleted at step 420 followed by the device's return to its normal operation at step 422.

Still referring to FIG. 4, registration of a smartphone device to a vehicle can be made simultaneously with the app download, as shown in step 424. Such a registration includes the transmission of an authenticator of the phone to the vehicle, such as the transmission of the phone's ESN in addition to the transmission of the VIN to the phone by the vehicle 200. Once the device 300 and vehicle 200 are registered to each other, the vehicle 200 is considered to be ready for a phone-enabled software update at step 426.

Those of ordinary skill in the art will recognize that downloading a software update for an embedded processor to a smart phone and then downloading the software from the phone to the vehicle is faster and less costly than having to return the vehicle to an authorized service center or dealer for an update. With that in mind, the foregoing description is for purposes of illustration only. The true scope of the invention is set forth in the following claims.

What is claimed is:

1. A system for providing software to an embedded vehicle computer in a motor vehicle, the system comprising:
a vehicle having an embedded processor and a communications device, the embedded processor and communications device being coupled to a bus through which signals can be exchanged between said embedded processor and said communications interface;
an extra-vehicle, mobile cellular communications device having a user interface and a file transfer interface configured to be communicatively coupled to the communications device in the vehicle, the extra-vehicle mobile cellular communications device having a processor coupled to both the user interface and the file transfer interface, the extra-vehicle, mobile cellular communications device also having a non-transitory memory device storing program instructions which when executed cause the extra-vehicle, mobile cellular communications device to:
wirelessly receive from a cellular network, a file containing executable instructions for said embedded processor;
store the wirelessly-received file in said non-transitory memory device; and
transmit the wirelessly-received file to the communications device in the vehicle through said file transfer interface, responsive to a second input at said user interface.

2. The system of claim 1, wherein the non-transitory memory device stores program instructions which when executed cause the extra-vehicle, mobile cellular communications device to authenticate itself to the vehicle, prior to transferring the stored, wirelessly-received file to the communications device.

3. The system of claim 1, wherein the file transfer interface is a Bluetooth transceiver and wherein the communications device of the vehicle is a Bluetooth transceiver.

4. The system of claim 1, wherein the file transfer interface comprises a connector and wherein the communications device of the vehicle is a connector on the vehicle, the file transfer interface additionally comprising a cable extending between the connector on the extra-vehicle mobile cellular communications device and the connector on the vehicle.

5. The system of claim 1, wherein the vehicle has a plurality of embedded processors, each embedded processor and said communications device being coupled to said bus, wherein program instructions in said non-transitory memory device for the processor of the extra-vehicle mobile cellular communications device include instructions, which when executed cause the extra-vehicle mobile cellular communications device to be able to:
receive files containing executable instructions for a plurality of said embedded processors; and
selectively transmit a first file for a first embedded processor and transfer a second file for a second embedded processor.

6. An apparatus for providing software to an embedded vehicle computer located in a vehicle having a plurality of embedded vehicle computers, each embedded vehicle computer being coupled to a vehicle bus, the apparatus comprising:
a communications device attached to the vehicle and coupled to said vehicle bus, the communications device configured to receive a file containing executable instructions for an embedded vehicle computer;
a non-transitory memory device coupled to the communications device and configured to store a received file comprising executable instructions for at least one embedded computer coupled to the vehicle bus.

7. The apparatus of claim 6, wherein the communications device comprises a connector, operatively coupled to said vehicle bus.

8. The apparatus of claim 6, wherein the communications device comprises a short-range wireless transceiver.

9. The apparatus of claim 6, wherein the communications device comprises a telematics unit having a processor and a short-range wireless transceiver.

10. The apparatus of claim 6, wherein the predetermined one of said plurality of embedded vehicle computers comprises at least one of:
an engine controller;
a telematics controller;
an anti-lock brakes controller; and
a global positioning system controller.

11. The apparatus of claim 6, wherein the communications device is configured to receive a file from a predetermined extra-vehicle mobile cellular communications device, responsive to the communications device receiving an authenticator for said file.

12. The apparatus of claim 11, wherein the authenticator validates a received file as originating from a manufacturer of the vehicle.

13. The apparatus of claim 11, further comprising a non-transitory memory device coupled to the communications device and wherein the communications device is configured to store at least a portion of a received file in said non-transitory memory device.

14. A mobile cellular communications device comprising:
a user interface;
a cellular communications transceiver;
a communications interface, configured to be coupled to the vehicle communications bus;
a processor operatively coupled to the user interface, the cellular transceiver and the communications interface; and
a non-transitory memory device storing program instructions for the processor, which when executed cause the processor to:
receive a file from the cellular communications transceiver, which is for an embedded vehicle computer;
store the received file in the non-transitory memory device;
retrieve the stored file from the non-transitory memory device; and
transmit the stored file from the communications interface.

15. The apparatus of claim 14, wherein the communications interface comprises a Bluetooth transceiver and wherein program instructions cause the processor to transmit the stored file from the Bluetooth transceiver.

16. The apparatus of claim 14, further comprising program instructions, which when executed cause the processor to transmit the stored file to a vehicle through the communications interface responsive to an input received at the user interface.

17. The apparatus of claim 14, further comprising program instructions, which when executed cause the processor to transmit an authenticator to the vehicle through the communications interface, prior to transmitting the stored file.

18. The apparatus of claim 14, further comprising program instructions, which when executed cause the processor to receive a file validator from the cellular communications transceiver prior to receiving a file from the cellular communications interface.

19. A method of updating software in an embedded computer located in a vehicle, the embedded computer being coupled to a vehicle bus, the method comprising:
receiving at a vehicle telematics unit, a file for the embedded computer that contains executable instructions for said embedded computer;
storing said file in a non-transitory memory device; and
transferring the file from the non-transitory memory device to the embedded computer, via the vehicle bus.

20. The method of claim 19, wherein the telematics unit comprises a Bluetooth transceiver and wherein the step of receiving at a vehicle telematics unit further comprises:
receiving the file at the Bluetooth transceiver.
